(19) United States
(12) Patent Application Publication
(10) Pub. No.: US 2010/0204063 A1
(43) Pub. Date: Aug. 12, 2010

(54) DNA CHIP PACKAGE AND METHOD FOR FABRICATING THE SAME

(75) Inventor: Tae-seok SIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/619,067

(22) Filed: Nov. 16, 2009

(30) Foreign Application Priority Data
Feb. 6, 2009 (KR) 10-2009-0009864

(51) Int. Cl. C40B 40/08; C40B 50/14

(52) U.S. Cl. 506/17; 506/30

(57) ABSTRACT

A DNA chip package includes; a base substrate, a photoresist layer disposed on the base substrate, at least one DNA chip mounting groove disposed in the photoresist layer and exposing the base substrate therethrough, and at least one DNA chip mounted in the at least one DNA chip mounting groove.

### CROSS-REFERENCE TO RELATED APPLICATION

This application claims priority to Korean Patent Application No. 10-2009-0009864, filed on Feb. 6, 2009, and all the benefits accruing therefrom under 35 U.S.C. §119, the content of which in its entirety is incorporated by reference.

### BACKGROUND

1. Field

One or more exemplary embodiments relate to a deoxyribonucleic acid (“DNA”) chip and a method of fabricating the DNA chip.

2. Description of the Related Art

As genome projects of organic bodies, including the human genome project, have been developed, a large amount of genetic information has also been produced. Accordingly, studies on how to interpret the genetic information have been made. DNA chips have garnered attention as tools for efficiently analyzing a sample using a large amount of genetic information accumulated through the genome projects. By using DNA chips, a large amount of information may be analyzed within a short period of time and automated analysis may be easily performed.

In the typical DNA chip, at least several hundreds to hundreds of thousands of genes are arrayed at a high density on a small solid such as a glass slide. The DNA chip, which is capable of searching a large number of gene expressions, may be used for interpretation of gene expressions, diagnosis of genes, diagnosis of gene mutation, and diagnosis of diseases.

A sample gene analysis process using a DNA chip includes a scanning process using an optical detection apparatus in order to detect an amount of fluorescent expression of a sample injected in a DNA chip. To facilitate the gene analysis process, reduce errors in the scanning process, and protect the DNA chip, the DNA chip is typically formed in the form of a DNA chip package mounted in a case that is formed of glass, ceramic, or plastic. However, when the case of the DNA chip package is formed of glass or ceramic, manufacturing costs of the DNA chip package increase. Also, when the case of the DNA chip package is formed of plastic, a planarization degree required in the scanning process is difficult to consistently manufacture.

### SUMMARY

One or more exemplary embodiments include a DNA chip package which reduces manufacturing costs and improves a degree of planarization, and a fabrication method thereof.

Additional aspects will be set forth in part in the description which follows and, in part, will be apparent from the description, or may be learned by practice of the embodiment.

An exemplary embodiment of a DNA chip package includes; a base substrate, a photoresist layer disposed on the base substrate, at least one DNA chip mounting groove disposed in the photoresist layer and which exposes the base substrate therethrough, and at least one DNA chip mounted in the at least one DNA chip mounting groove.

In one exemplary embodiment, the base substrate may include glass.

In one exemplary embodiment, the photoresist may include an epoxy resin based material.

In one exemplary embodiment, a thickness of the photoresist layer may be from about 500 μm to about 4 mm.

An exemplary embodiment of a method of fabricating a DNA chip package includes; depositing photoresist on a base substrate to form a photoresist layer, partially removing the photoresist layer to expose the base substrate through masking, exposure, and development to form at least one DNA chip mounting groove, and mounting at least one DNA chip in the at least one DNA chip mounting groove.

In one exemplary embodiment, the photoresist includes an epoxy resin based material and may be coated on the base substrate.

In one exemplary embodiment, a thickness of the photoresist layer may be formed to be from about 500 μm to about 4 mm.

### BRIEF DESCRIPTION OF THE DRAWINGS

The above and/or other aspects, advantages and features will become more apparent and more readily appreciated from the following description of the exemplary embodiments, taken in conjunction with the accompanying drawings of which:

FIG. 1 is a front perspective view of an exemplary embodiment of a DNA chip package;

FIGS. 2A-2C are front perspective views illustrating an exemplary embodiment of a method of fabricating the DNA chip of FIG. 1; and

FIG. 2D is an exploded front perspective view illustrating an exemplary embodiment of a method of fabricating the DNA chip of FIG. 1.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

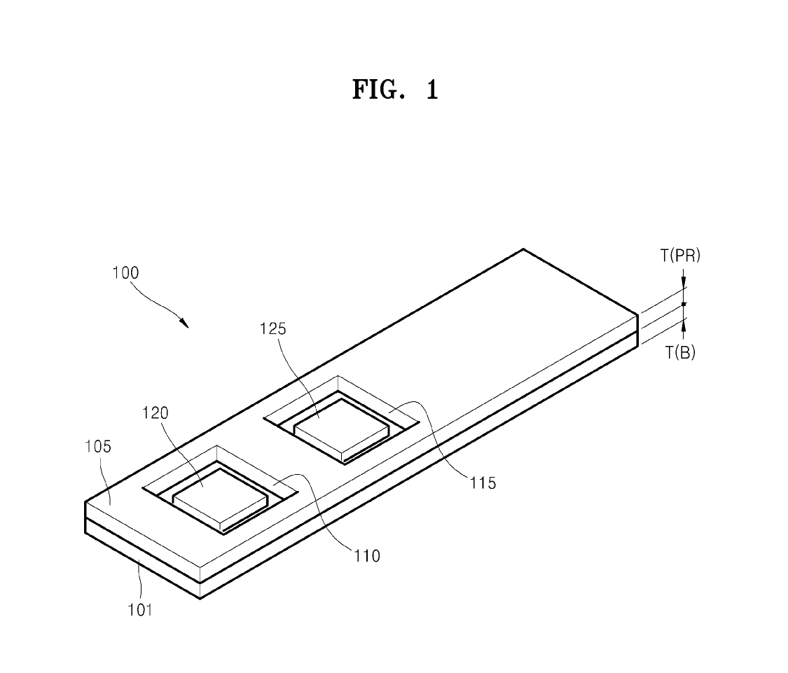

FIG. 1 is a front perspective view of an exemplary embodiment of a DNA chip package 100. Referring to FIG. 1, the DNA chip package 100 according to the present embodiment includes a base substrate 101, a photoresist (PR) layer 105 deposited on the base substrate 101, a plurality of DNA chip mounting grooves 110 and 115 formed by partially removing the PR layer 105 to expose the base substrate 101, and DNA chips 120 and 125 mounted in the DNA chip mounting grooves 110 and 115. In an alternative exemplary embodiment, the DNA chip mounting grooves 110 and 115 may be formed by forming the PR layer 105 to include areas where it is not deposited on the base substrate 101, rather than by subsequent removal of the PR layer 105. Exemplary embodiments of the base substrate 101 may be formed of glass, ceramic, or silicon (Si) to satisfy a high planarization condition. Further considering costs and shock-resistant characteristics, exemplary embodiments of the base substrate 101 may be fabricated of a glass plate. In one exemplary embodiment, the thickness T(B) of the base substrate 101 may be about 1 mm.

The PR layer 105 is formed of a photoresist material. The PR layer 105 is deposited to be thicker than the thickness of the DNA chips 120 and 125. In one exemplary embodiment, the PR layer 105 is thicker than the thickness of a PR deposition in a typical semiconductor process. When a sample including DNA is injected into the DNA chip mounting grooves 110 and 115 for gene analysis, the DNA chips 120 and 125 are emerged in the sample. In one exemplary embodiment, the thickness T(PR) of the PR layer 105 may be from about 500 μm to about 4 mm. In one exemplary embodiment, the PR may include an epoxy resin based material. For example, SU-8™ that is a product of MicroChem Corp. (“MCC”) may be used as the PR. The PR including the epoxy based material is not only closely contacted on the base substrate 101, but also has a so-called self-planarization characteristic wherein the material thereof widely spreads with a high planarization. Thus, the planarization characteristic of the DNA chip package 100 that is finished may be easily improved.

In the present exemplary embodiment, each of the DNA chips 120 and 125 includes several hundreds to hundreds of thousands of genes, for example, DNAs, are arrayed in a small space such as a semiconductor chip. The DNA has an intrinsic characteristic of forming a double helix by strong and selective combination between adenine and thymine and between cytosine and guanine. The DNA chips 120 and 125 may use the nature of the DNA that the DNA has a complementary and selective combination. That is, a DNA probe is attached to each of the DNA chips 120 and 125 in order to bind with a target DNA in the sample. When a sample including a DNA to be analyzed is supplied to the DNA chips 120 and 125, only a sample DNA having a complementary sequence is coupled to the DNA probe. Several hundreds to hundreds of thousands of types of DNA probes having different base sequences are attached to each of the DNA chips 120 and 125. Since the sort of a DNA included in the sample to be analyzed is not limited, a search at a tremendous speed is possible. Since a DNA chip package user previously knows the sequence of the DNA probes on the DNA chips 120 and 125 according to the position of the DNA probes attached to each of the DNA chips 120 and 125, the DNA chip package user recognizes where the DNAs in the sample are coupled at which position on the DNA chips 120 and 125, thereby identifying the DNA in the sample. To quantitatively detect the combination between the DNA probe and the DNA included in the sample, the DNA in the sample is processed with a fluorescent indication so that the DNA in the sample may be identified by scanning the strength of fluorescence developed on the DNA chips 120 and 125. When the fluorescence is strong, it may be determined that many complementary DNAs to the DNA probe are included in the sample.

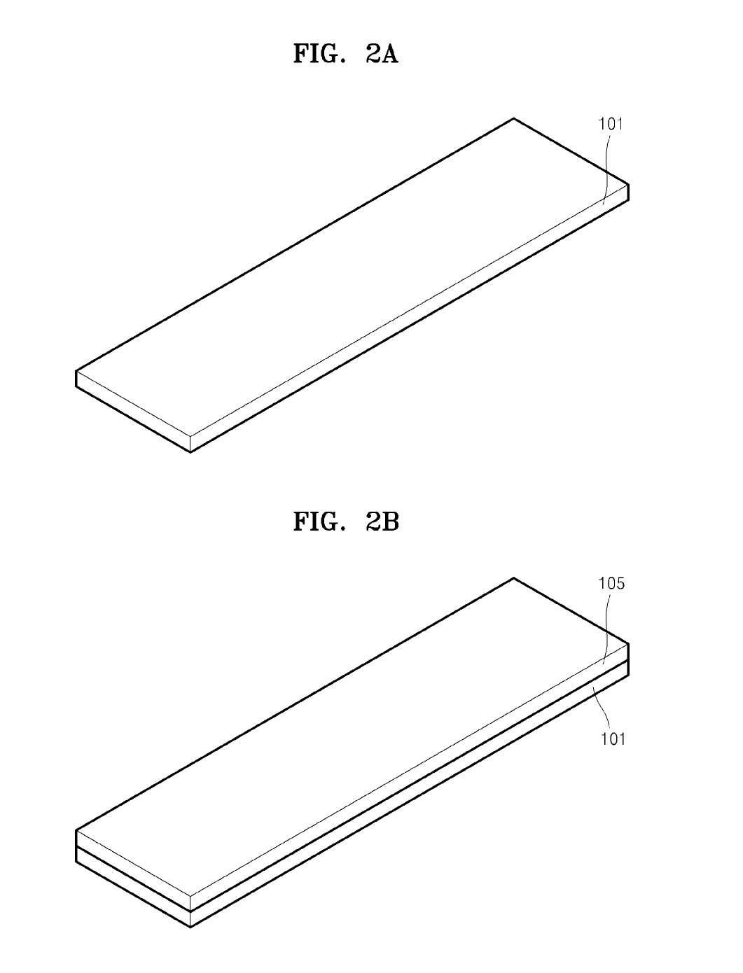

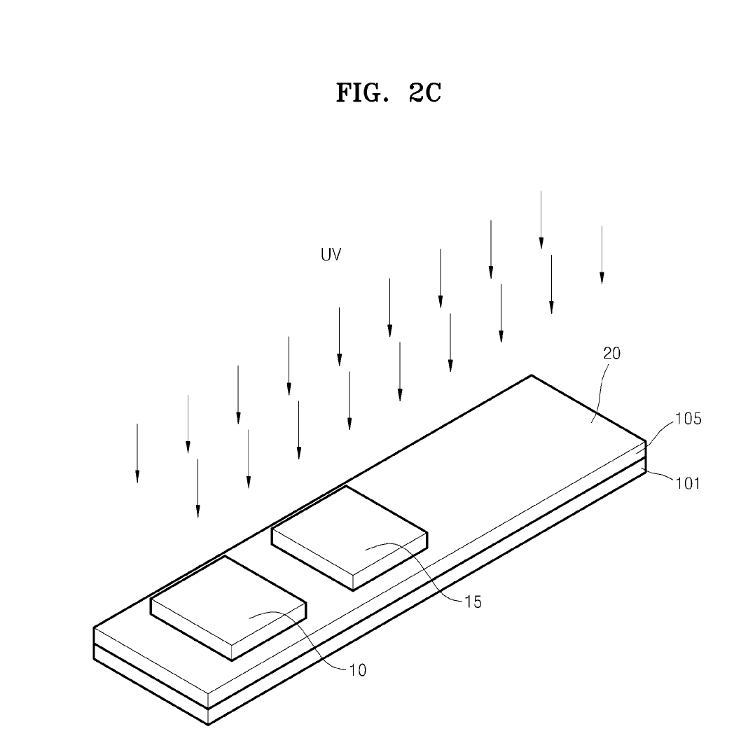

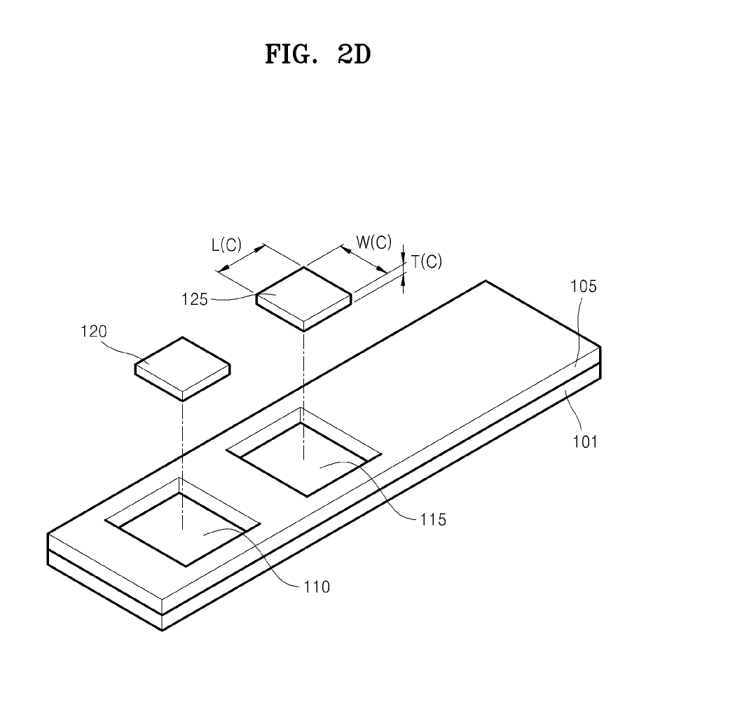

Referring to FIG. 2D, in one exemplary embodiment the thickness T(C) of each of the DNA chips 120 and 125 may be about 500 μm to about 700 μm, which is less than or equal to the thickness T(PR) of the PR layer 105. In one exemplary embodiment, each of the length L(C) and width W(C) of each of the DNA chips 120 and 125 may be about 1 cm, but the present invention is not limited thereto and instead various shapes and sizes of DNA chip may be used.

FIGS. 2A-2D are front perspective views illustrating an exemplary embodiment of a method of fabricating the DNA chip 100 of FIG. 1. Referring to FIG. 2A-2D, the present exemplary embodiment of a method of fabricating the DNA chip 100 includes the operations of preparing a base substrate 101 (refer to FIG. 2A), forming the PR layer 105 (refer to FIG. 2B), forming the DNA chip mounting grooves 110 and 115 (refer to FIGS. 2C and 2D), and mounting the DNA chips 120 and 125 (refer to FIG. 2D).

Referring to FIG. 2A, in the preparing of the base substrate 101, a substrate formed of glass, or other materials having similar characteristics, may be prepared. Also, in one exemplary embodiment the base substrate 101 may be washed using a cleaning solution such as sulphuric acid (H₂SO₄) to remove impurities and improve planarization of an upper surface thereof.

Referring to FIG. 2B, in an exemplary embodiment of the forming of the PR layer 105, the PR layer 105 is formed by depositing PR on the base substrate 101. For example, in one exemplary embodiment the PR including an epoxy resin based material may be coated on the base substrate 101. The PR layer 105 may be formed to have a thickness T(PR) of about 500 μm to about 4 mm (refer to FIG. 1). The surface of the PR layer 105 is solidified to a highly planarization state due to the self-planarization characteristic of the epoxy resin based material.

Referring to FIG. 2C, in the forming of the DNA chip mounting grooves 110 and 115 (refer to FIG. 2D), the DNA chip mounting grooves 110 and 115 are formed by partially removing the PR layer 105 to expose the base substrate 101 through masking, exposure, and development. For example, in an exemplary embodiment wherein SU-8™ that is a product of MCC is used as the PR, the SU-8™ is so-called negative PR so that, as PR molecules in an area where light is incident are chain-connected, an area where the light is not incident may be removed during the process of development. Thus, masks 10 and 15 are arranged only in areas corresponding to the DNA chip mounting grooves 110 and 115 to be removed and a remaining area 20 is exposed to a light source such as an ultra violet ray. However, unlike the exemplary embodiment illustrated in FIG. 2C, alternative exemplary embodiments include configurations wherein positive PR may be used, along with a different series of masks (not shown). In addition, as described above, alternative exemplary embodiments include configurations wherein the PR layer 105 may be formed so that no removal of PR is necessary to form the DNA chip mounting grooves 110 and 115, e.g., the PR layer may be deposited only on the desired areas without depositing the PR layer on the DNA chip mounting grooves 110 and 115.

When the masks 10 and 15 are removed and the PR layer 105 is developed using a developer, the DNA chip mounting grooves 110 and 115 where the base substrate 101 is exposed are formed as illustrated in FIG. 2D. In the mounting the DNA chip mounting operation, the DNA chips 120 and 125 are attached, one by one, to the DNA chip mounting grooves 110 and 115 using an adhesive, exemplary embodiments of which include a chip attach bond. Alternative exemplary embodiments include configurations wherein the DNA chips 120 and 125 are attached substantially simultaneously. Alternative exemplary embodiments also include configurations wherein additional DNA chips may be added to the DNA chip package 100.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A DNA chip package comprising:
a base substrate;
a photoresist layer disposed on the base substrate;
at least one DNA chip mounting groove disposed in the photoresist layer and which exposes the base substrate therethrough; and
at least one DNA chip mounted in the at least one DNA chip mounting groove.

2. The DNA chip package of claim 1, wherein the base substrate comprises glass.

3. The DNA chip package of claim 1, wherein the photoresist comprises an epoxy resin based material.

4. The DNA chip package of claim 1, wherein a thickness of the photoresist layer is from about 500 μm to about 4 mm.

5. The DNA chip package of claim 1, wherein the photoresist layer includes a positive photoresist material.

6. The DNA chip package of claim 1, wherein the photoresist layer includes a positive photoresist material.

7. The DNA chip package of claim 1, wherein the at least one DNA chip mounting groove is formed by partially removing the photoresist layer to expose the underlying base substrate.

8. A method of fabricating a DNA chip package, the method comprising:
depositing photoresist on a base substrate to form a photoresist layer;
partially removing the photoresist layer to expose the base substrate through masking, exposure, and development to form at least one DNA chip mounting groove; and
mounting at least one DNA chip in the at least one DNA chip mounting groove.

9. The method of claim 8, wherein the base substrate comprises glass.

10. The method of claim 8, wherein the photoresist includes an epoxy resin based material and is coated on the base substrate.

11. The method of claim 8, wherein a thickness of the photoresist layer is formed to be from about 500 μm to about 4 mm.
